(19) United States
(12) Patent Application Publication
(10) Pub. No.: US 2003/0020577 A1
(43) Pub. Date: Jan. 30, 2003

(54) MAGNET COIL METHOD FOR PRODUCING A MAGNET COIL MAGNET VALVE AND FUEL PUMP EMPLOYING THE MAGNET VALVE

(76) Inventors: Irene Jennrich, Winnenden (DE); Markus Muzic, Murr (DE); Hans-Joachim Schulz, Grand Rapids, MI (US); Andreas Eckert, Stuttgart (DE); Wolfgang Endres, Remshalden (DE); Hubert Greif, Markgroeningen (DE); Cornelius Gaida, Korb (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/914,467

(22) PCT Filed: Dec. 22, 2000
(86) PCT No.: PCT/DE00/04588

(30) Foreign Application Priority Data
Dec. 29, 1999 (DE) 199 63 718.0

(51) Int. Cl. H01F 7/08

(52) U.S. Cl. 335/220

(57) ABSTRACT

The invention relates to a winding that is received in a magnet pot. The winding is formed of a wire, in particular baked enamel wire, which is provided with a coating that causes the winding to hold together. In producing the magnet coil, the winding is inserted into the magnet pot and then potted with a low-viscosity potting material.

### PRIOR ART

The invention relates to a magnet coil with a winding, which is received in a magnet pot. The invention also relates to a method for producing a magnet coil, and to a magnet valve and a fuel pump.

In German Patent Disclosure DE 197 14 812 A1, a conventional magnet coil is described. The conventional magnet coil is formed by a winding wire, which is wound onto a winding carrier. Such a magnet coil is used, among other places, in magnet valves that are used in fuel pumps of internal combustion engines for controlling the pumping quantity and the course of pumping. In operation, the magnet valves are bathed at least in part by fuel subjected to high pressure. To prevent contact with the fuel, it is necessary to encapsulate the magnet coil. Especially in common rail or unit fuel injector systems, magnet valves with extremely short switching times are needed. Because of the switching times, the magnet coil warms up during operation. The thermal stress on the magnet coil in operation is undesired.

The object of the invention is to furnish a magnet coil, a method for producing a magnet coil, a magnet valve and a fuel pump, in which the thermal coupling of the winding of the magnet coil to its surroundings is improved.

In a magnet coil having a winding that is received in a magnet pot, this object is attained in that the winding is formed of a wire, in particular baked enamel wire, which is provided with a coating that causes the winding to hold together. The intrinsically stable winding offers the advantage that a separate winding carrier can be dispensed with. This advantageously reduces the installation space required for the magnet coil.

One particular type of embodiment of the magnet coil of the invention is characterized in that the winding is disposed in a toroidal cup. The toroidal cup serves on the one hand to pre-mount the winding, and on the other, the toroidal cup forms a protective sleeve for the winding when the winding, in the installed state, is not entirely surrounded by the magnet pot.

A further particular type of embodiment of the magnet coil of the invention is characterized in that two encompassing chamfers are embodied in the interior of the magnet pot. The chamfers in the magnet pot serve to achieve reliable sealing between the toroidal cup and the magnet pot. Instead of the chamfer, corresponding bumps on the magnet pot can also be provided.

A further particular type of embodiment of the magnet coil of the invention is characterized in that a tubular plastic part is mounted on the magnet pot. The tubular plastic part serves to lead the winding wire out of the magnet pot. In addition, the tubular plastic part can be used as a tool for inserting and orienting the winding. Furthermore, the winding with the tubular plastic part can be fixed with potting composition in the magnet pot in the potting process.

The aforementioned object is attained in a method for producing a magnet coil as described above in that the winding is inserted into the magnet pot and potted with a low-viscosity potting material. A very compact magnet coil is created by the method of the invention. The spacings between the winding and the magnet pot can be dimensioned much shorter than in conventional magnet coils produced by spray-coating with plastic. Expressed in numbers, this means economies of several millimeters of wall thickness. This offers the advantage that the power loss of the magnet coil that occurs in operation, in the form of heat, can be better dissipated. In potting of the magnet coil, all the interstices in the winding are filled with potting composition. In this way the winding is impregnated with potting composition, as it were. This leads to a marked improved improvement in the mechanical stability and thermal conductivity of the winding. Furthermore, the potting composition assures that no fluid can penetrate into the winding.

An especially advantageous effect is attained if a magnet coil as described above is built into a magnet valve for controlling the pumping quantity and course of pumping of a fuel pump.

Further advantages, characteristics and details of the invention will become apparent from the ensuing description, in which two exemplary embodiments of the invention are described in detail, in conjunction with the drawing. The characteristics recited in the claims and mentioned in the description can each be essential to the invention individually or in arbitrary combination.

### DRAWINGS

Shown in the drawing are:

FIG. 1, a first embodiment of a magnet coil of the invention in longitudinal section;

FIG. 2, a second embodiment of a magnet coil of the invention in longitudinal section; and

FIG. 3, an enlarged view of the detail X of FIG. 2.

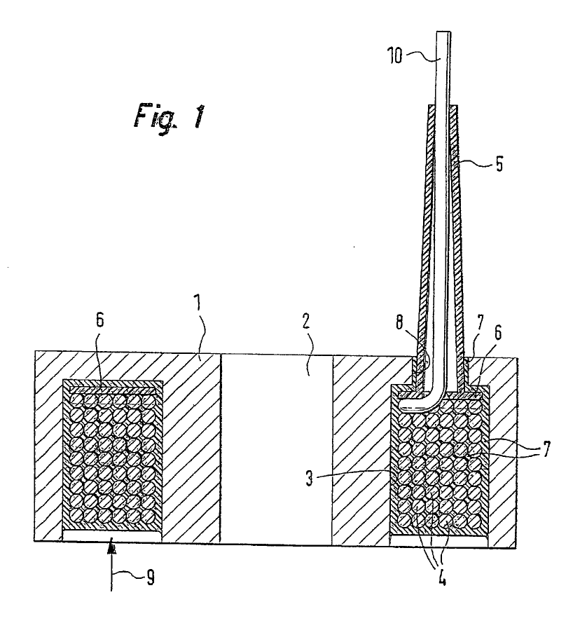

In FIG. 1, a magnet pot 1 is seen in longitudinal section. The magnet pot 1 has the form of a circular cylindrical disk, with a central bore 2. An annular chamber 3 is recessed out of the magnet pot 1 and serves to receive a winding 4 of copper wire. A tapering tube 5 protrudes with its thicker end through an opening 8 into the annular chamber 3 in the magnet pot 1. On its thicker end, the tube 5 merges with an annular disk 6 with a rectangular cross section. One end 10 of the copper wire winding 4 is passed through the tube 5. The end 10 serves to connect the winding to an electrical power supply. It is understood that the magnet coil shown includes one further terminal for carrying current away, but this is not shown.

The winding 4 is formed of so-called baked enamel wire. This involves coated copper wire. The baked enamel assures an intrinsically stable connection of the winding 4.

The interstices in the winding 4, like the gaps between the winding 4 and the magnet pot 1, are filled with a potting composition 7. The potting composition is introduced, as indicated by an arrow 9, through an open end face of the annular chamber 3. The winding 4 is completely penetrated and surrounded by the potting composition 7.

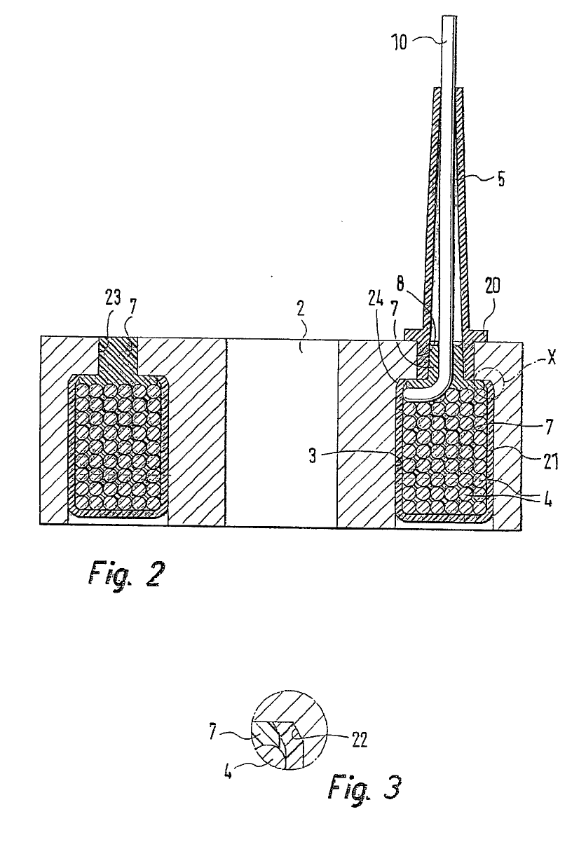

In the second embodiment, shown in FIG. 2, of a magnet coil of the invention, for the sake of simplicity the same reference numerals as in the first embodiment shown in FIG. 1 are used to designate the same elements. To avoid repetition, only the differences between the two embodiments will be addressed below.

In the second embodiment, shown in FIG. 2, of a magnet coil of the invention, the winding 4 is received in a toroidal cup 21, which is open on one face end. A chamfer 22, which can be seen best in the enlarged detail of FIG. 3, is embodied in the interior of the annular chamber 3. An oppositely oriented chamfer 24 is embodied concentrically with the chamfer 22. The chamfers 22 and 24 cooperate with the edges of the toroidal cup 21 in order to effect good sealing off from the magnet pot 1.

A tube 5 on which a flange 20 is embodied is inserted into the opening 8 in the magnet pot 1. On the outside, the flange 20 rests on the magnet pot 1.

Inside the toroidal cup 21, the winding 4 is penetrated and surrounded by potting composition 7. The potting composition 7 is introduced into the magnet pot 1 through a separate opening 23. As seen in FIG. 2, the potting composition 7 is also disposed in the openings 8 and 23 in the magnet pot 1. As a result, an especially good sealing action is achieved.

According to the present invention, an intrinsically stable magnet coil is produced by the use of a baked enamel wire. As a result, a winding carrier, required in conventional magnet coils, and contact lugs can be omitted. The coil wire is extended outside directly from the coil chamber. The baked enamel coil is not spray-coated, like conventional coils provided with carriers, but instead is potted. The potting of the baked enamel coil can be done either directly in the magnet pot or in a toroidal cup. The coil can be pre-mounted in the toroidal cup.

The tubes 5 take on the task of guiding the wire. By the capillary action of the potting composition, the potting composition rises in the plastic tubes 5 and thus improves the hydraulic sealing and the mechanical stability of the coil.

One essential advantage in the carrierless coil is its superiority in terms of installation space. Using the baked enamel wire means that the wall thicknesses for sheathing the winding 4 can be reduced from 1.0 mm to 0.1 mm. In comparison with conventional magnet coils, a total of approximately 1.5 to 2 mm of wall thickness can thus be saved on each side of the magnet coil. The advantages in terms of installation space have an especially favorable effect whenever the magnet valve of the invention is disposed in common rail systems or unit fuel injector systems in the cylinder head of the internal combustion engine. Because less installation space is needed, the magnetic circuit can be embodied more compactly. The result is lower eddy current losses and stray losses of the magnetic circuit. A faster magnetic force buildup and abatement is thus possible.

In the thermal performance of the magnet coil of the invention, improvements are attained from two standpoints. First, because of the markedly lesser wall thicknesses between the winding and the magnet pot, lower absolute temperatures are made possible. Second, lesser temperature gradients above the coil are attained. It is especially advantageous in this respect that the coil is completely impregnated with potting composition, and the thermal conductivity of the coil is thus improved.

Compared to conventional versions, water or fuel cannot penetrate the coil from either the outside or the inside and destroy the enamel insulation by way of hydrolysis, oxidation and rust.

1. A magnet coil having a winding (4) that is received in a magnet pot (1), characterized in that the winding (4) is formed of a wire, in particular baked enamel wire, which is provided with a coating that causes the winding (4) to hold together.

2. The magnet coil of claim 1, characterized in that the winding (4) is disposed in a toroidal cup (21).

3. The magnet coil of claim 2, characterized in that two encompassing chamfers (22) are embodied in the interior of the magnet pot (1).

4. The magnet coil of one of the foregoing claims, characterized in that a tubular plastic part (5) is mounted on the magnet pot (1).

5. A method for producing a magnet coil of one of the foregoing claims, characterized in that the winding (4) is inserted into the magnet pot (1) and potted with a low-viscosity potting material (7).

6. A magnet valve for controlling the pumping quantity and/or the course of pumping of a fuel pump, characterized by a magnet coil of one of claims 1-4.

7. A fuel pump for pumping fuel in an internal combustion engine, characterized by a magnet valve of claim 6.
